(19) United States
(12) Patent Application Publication
(10) Pub. No.: US 2023/0289375 A1
(43) Pub. Date: Sep. 14, 2023

(54) STORAGE MEDIUM, SEARCH DEVICE, AND SEARCH METHOD

(71) Applicant: Fujitsu Limited, Kawasaki-shi (JP)

(72) Inventor: Shogo SHIMURA, Kawasaki (JP)

(73) Assignee: Fujitsu Limited, Kawasaki-shi (JP)

(21) Appl. No.: 18/069,505

(22) Filed: Dec. 21, 2022

(30) Foreign Application Priority Data
Mar. 11, 2022 (JP) 2022-038611

(51) Int. Cl. G06F 16/33

(52) U.S. Cl. CPC G06F 16/3347

(57) ABSTRACT

A non-transitory computer-readable storage medium storing a search program that causes at least one computer to execute a process, the process includes generating, when search text is received, a first vector that indicates the search text based on a vector that indicates a word included in the search text; generating, when a word that indicates negation is included in the search text, a second vector obtained by rotating the first vector by a certain angle; executing text search processing by using the second vector when the second vector is generated; and executing the text search processing by using the first vector when the second vector is not generated.

### CROSS-REFERENCE TO RELATED APPLICATION

This application is based upon and claims the benefit of priority of the prior Japanese Patent Application No. 2022-38611, filed on Mar. 11, 2022, the entire contents of which are incorporated herein by reference.

### FIELD

A disclosed technique relates to a storage medium, a search device, and a search method.

### BACKGROUND

It has been common practice to search a document related to search text based on a meaning of the search text serving as a query (hereinafter, referred to as “semantic search”). In the semantic search, machine learning is executed on the meaning of a word in a document group to be searched or a document group for learning. Based on the meaning of the word obtained by the machine learning, a document search is executed by analyzing the meaning of search text or a document to be searched (hereafter referred to as a “search target document”). For example, in the semantic search, the meaning of a word is obtained as a distributed representation (vector) by the machine learning. By using a distributed representation of a word, search text and a search target document are also converted into a distributed representation. In the semantic search, by calculating the distance between the distributed representation of search text and the search target document, it is determined whether the search text and the search target document are semantically close to or far from each other, and the determination result is reflected in the search result. Accordingly, it is possible to search for a document that would have been missed in a search using a simple character string match.

For example, a method for performing a secure Boolean search for an encrypted document has been proposed. In this method, each document is characterized by a set of keywords, and all keywords characterizing all documents form an index, and are converted into an orthonormal basis in which each keyword of the index corresponds to one and only vector of the orthonormal basis. Each document is associated with a resultant vector in the span of the orthonormal basis, and the resultant vector corresponds to all documents stored in the encrypted search server. According to this method, a search query is received from a querier, the search query is converted into one query matrix, and an overall result is determined based on a result of multiplication between the query matrix and the resultant vector.

Japanese National Publication of International Patent Application No. 2015-528609 is disclosed as related art.

### SUMMARY

According to an aspect of the embodiments, a non-transitory computer-readable storage medium storing a search program that causes at least one computer to execute a process, the process includes generating, when search text is received, a first vector that indicates the search text based on a vector that indicates a word included in the search text; generating, when a word that indicates negation is included in the search text, a second vector obtained by rotating the first vector by a certain angle; executing text search processing by using the second vector when the second vector is generated; and executing the text search processing by using the first vector when the second vector is not generated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a configuration of a search system;

FIG. 2 is a functional block diagram of a data storage device, a generation device, and a search device;

FIG. 3 is a diagram illustrating an example of a document DB;

FIG. 4 is a diagram illustrating an example of a word vector DB;

FIG. 5 is a diagram illustrating an example of a document vector DB;

FIG. 6 is a diagram illustrating an example of a sentence vector;

FIG. 7 is a diagram for explaining a problem in a case where a sentence vector of a negative sentence is inverted;

FIG. 8 is a diagram for explaining a problem in a case where a sentence vector of a negative sentence is inverted;

FIG. 9 is a diagram for explaining a case where a sentence vector of a negative sentence is rotated;

FIG. 10 is a diagram for explaining a case where a sentence vector of a negative sentence is rotated;

FIG. 11 is a block diagram schematically illustrating a configuration of a computer functioning as a generation device;

FIG. 12 is a block diagram schematically illustrating a configuration of a computer functioning as a search device;

FIG. 13 is a flowchart illustrating an example of generation processing; and

FIG. 14 is a flowchart illustrating an example of search processing.

### DESCRIPTION OF EMBODIMENTS

In the semantic search, the distributed representation of a word is made by executing machine-learning on the base form of a word, and thus there is a problem in that the distributed representation of an affirmative sentence and the distributed representation of a negative sentence are the same. For example, there is a problem in that search results for search text are the same regardless of whether the search target document is an affirmative sentence or a negative sentence.

According to one aspect, an object of the disclosed technique is to search a document by distinguishing between affirmative and negative sentences.

Hereinafter, an example of the embodiment according to the disclosed technique will be described with reference to the drawings.

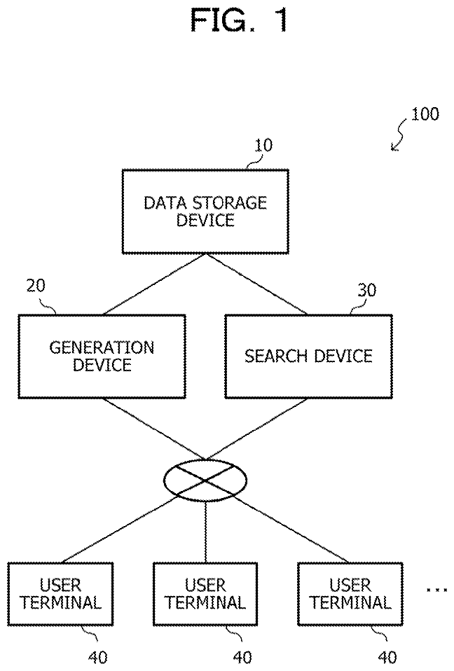

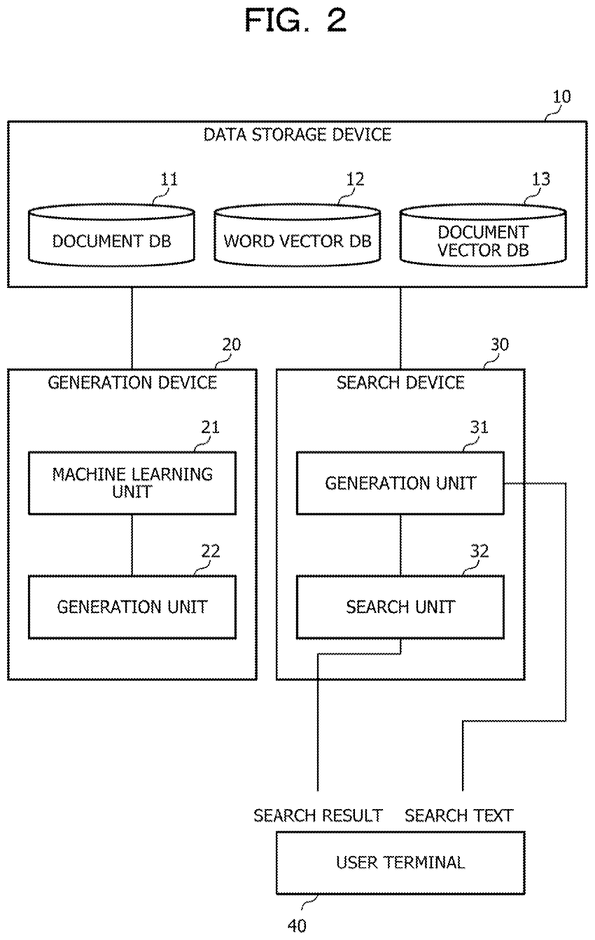

As illustrated in FIG. 1, a search system 100 according to the present embodiment includes a data storage device 10, a generation device 20, a search device 30, and a user terminal 40. FIG. 2 illustrates a functional configuration of each of the data storage device 10, the generation device 20, and the search device 30.

The user terminal 40 is an information processing terminal used by a user and is, for example, a personal computer, a tablet terminal, a smartphone, or the like. The user terminal 40 transmits search text to be a query for a document search input by a user to the search device 30. The search text may be a document including one or more sentences. The user terminal 40 acquires a search result transmitted from the search device 30 and displays the search result on a display device.

As illustrated in FIG. 2, the data storage device 10 stores a document database (DB) 11, a word vector DB 12, and a document vector DB 13.

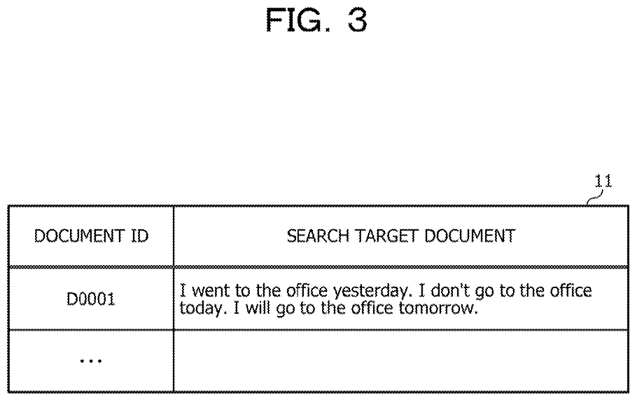

A plurality of search target documents is stored in the document DB 11. FIG. 3 illustrates an example of the document DB 11. In the example illustrated in FIG. 3, a document ID as identification information of each search target document and the search target document (text data) are stored in the document DB 11 in association with each other.

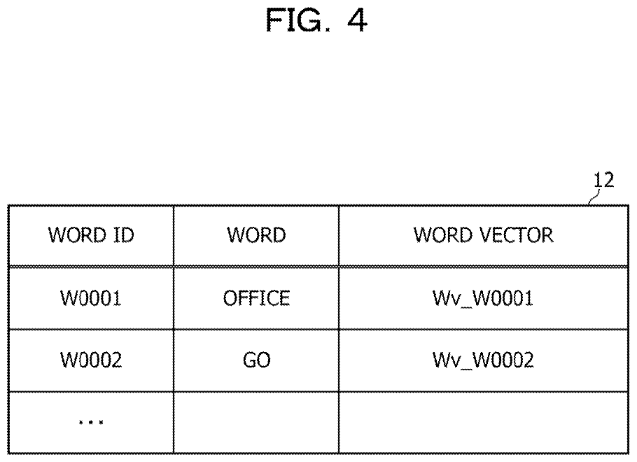

A plurality of word vectors (details will be described later) generated by machine learning in the generation device 20 is stored in the word vector DB 12. FIG. 4 illustrates an example of the word vector DB 12. In the example illustrated in FIG. 4, a word ID as identification information of each word, a word (text data), and a word vector of the word are stored in the word vector DB 12 in association with each other.

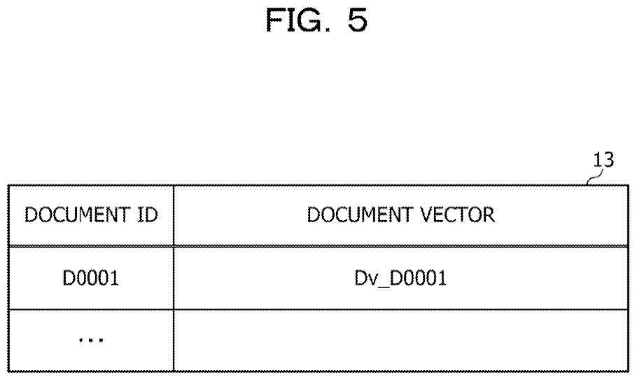

For each search target document stored in the document DB 11, a plurality of document vectors (details will be described later) generated in the generation device 20 is stored in the document vector DB 13. FIG. 5 illustrates an example of the document vector DB 13. In the example illustrated in FIG. 5, a document ID and a document vector of a search target document indicated by the document ID are stored in the document vector DB 13 in association with each other.

As illustrated in FIG. 2, the generation device 20 functionally includes a machine learning unit 21 and a generation unit 22.

The machine learning unit 21 acquires each of the plurality of search target documents stored in the document DB 11, performs morphological analysis on each acquired search target document, and extracts a base form of a word having a meaning, a part of speech of the word being a noun, a verb, an adjective, or the like, from a morphological analysis result. By executing machine learning by using, for example, a neural network, the machine learning unit 21 generates a word vector such as Word2Vec as a distributed representation of the meaning of the word, from the extracted base form of the word. The machine learning unit 21 stores the generated word vector in the word vector DB 12.

The generation unit 22 acquires the plurality of search target documents stored in the document DB 11 and a plurality of word vectors stored in the word vector DB 12, and generates a document vector representing each search target document by using the word vector.

As a general method of generating a document vector by using a word vector, for example, calculating a document vector Dv of a document composed of N types of words by Formula (1) below is considered.

$$Dv = {\sum }_{i}^{N} TF ( i ) \cdot IDF ( i ) \cdot Wv ( i ) \qquad ( 1 )$$

Here, Wv (i) is a distributed representation of a word i that appears in a document, for example, a word vector. TF(i) is a value obtained by dividing the number of occurrences of the word i in the document by the number of occurrences of all words, for example, the frequency of occurrence of the word i in the document. IDF(i) is an inverse of a value indicating how many documents use the word i, in a document group.

The word vector generated by the machine learning unit 21 is the distributed representation of the base form of a word, and as for the word having no meaning among words included in the search target document, the word vector is not generated by the machine learning. For this reason, in a case where the document vector is calculated as in above Formula (1), the document vectors between the affirmative sentence and the negative sentence are the same. For example, in both the document “I go to the office” and the document “I don't go to the office”, since document vectors each are calculated by using only word vectors of two words “office” and “go”, the document vectors are the same. For this reason, it is not possible to perform a search in which the affirmative sentence “I go to the office” and the negative sentence “I don't go to the office” are distinguished from each other.

The generation unit 22 generates a document vector based on each word vector and one or a plurality of words included in the search target document, and in a case where a word indicating negation is not included in the search target document, this document vector is set as a document vector to be used for search processing. By contrast, in a case where a word indicating negation is included in the search target document, the generation unit 22 sets a document vector rotated by a specific angle as the document vector to be used for the search processing.

In a case where the search target document includes a plurality of sentences, the generation unit 22 generates a sentence vector based on each word vector and one or a plurality of words included in the sentence for each sentence. When there is no sentence including a word indicating negation in the search target document, the generation unit 22 generates a document vector by combining sentence vectors of the plurality of sentences. On the other hand, when there is a sentence including a word indicating negation in the search target document, by rotating a sentence vector of the sentence including a word indicating negation by a specific angle, sentence vectors of a plurality of sentences are combined to generate a document vector.

For example, the generation unit 22 divides each of the search target documents acquired from the document DB 11 into sentences. For example, the generation unit 22 divides the search target document into sentences based on a reading point, a clause, an exclamation mark, a question mark, parentheses, and the like. For each sentence, the generation unit 22 calculates a sentence vector Sv according to Formula (2) below. However, in Formula (2), TF (i) is not the number of occurrences of the word i in the search target document but a value obtained by dividing the number of occurrences of the word i in the sentence by the number of occurrences of all words in the search target document.

Sv=Σᵢ^{N}TF(i)·IDF(i)·Wv(i) (2)

The generation unit 22 determines whether or not each sentence is a negative sentence based on whether or not the sentence ends with a word representing negation such as “Nai (auxiliary verb)”, or “Nu (auxiliary verb)” in Japanese. The word representing negation may be determined in advance. The generation unit 22 rotates a sentence vector of a sentence determined to be the negative sentence by a specific angle in a specific biaxial plane. Although the plane to be rotated may be arbitrarily determined, the same plane is set to be used for all the sentence vectors to be rotated.

For example, the specific angle may be an angle included in a predetermined range centered at 90 degrees or −90 degrees (for example, 90 degrees or −90 degrees). A predetermined range may be a range of 90 degrees−α degrees to 90 degrees+β degrees, or −90 degrees+α degrees to −90 degrees−β degrees (α and β are values greater than 0 and less than 90). Since the effect of distinguishing between the negative sentence and the affirmative sentence decreases when the rotation angle is too small, the value of α may be determined in advance so as to obtain this effect. In a case where the angle at which the vector is rotated is close to 180 degrees or −180 degrees, a problem occurs in which components of the negative sentence are canceled by components of the affirmative sentence (details will be described later), and thus, the value of β may be determined in advance such that this problem does not occur. For example, a document of a test case and search text may be prepared, and an angle at which a search result for the search text is good may be found and set by a brute-force method.

The generation unit 22 amplifies the sentence vector of the negative sentence that is rotated by the specific angle by a predetermined factor. The reason for this is that, in many cases, a percentage of affirmative sentences is overwhelmingly larger than that of negative sentences in a document, and since a document vector is a sum of sentence vectors (details will be described later), this is to ensure that components of the negative sentence are not embedded in the document vector due to performance of amplification. A predetermined factor may be a fixed value determined in advance, or may be a value based on a ratio between affirmative sentences and negative sentences included in the search target document. For example, in a case where the search target document includes four affirmative sentences and one negative sentence, the generation unit 22 may amplify the sentence vector of the rotated negative sentence by four times.

The generation unit 22 generates a document vector by combining a sentence vector of the affirmative sentence and a sentence vector of the negative sentence that is rotated by a specific angle and amplified. For example, in a case where M sentences are included in the search target document, the generation unit 22 calculates the document vector Dv by Formula (3) below. Sv (j) in Formula (3) is a sentence vector that is rotated by a specific angle and amplified when a sentence j is a negative sentence. The generation unit 22 stores the generated document vector in the document vector DB 13.

Dv=Σⱼ^{M}Sv(j) (3)

As illustrated in FIG. 2, the search device 30 functionally includes a generation unit 31 and a search unit 32.

The generation unit 31 acquires search text transmitted from the user terminal 40, and generates a search vector representing the search text. A method of generating a search vector is similar to the method of generating a document vector of a search target document in the generation unit 22 of the generation device 20. For example, the generation unit 31 divides the acquired search text into sentences, and calculates a sentence vector for each sentence by using the word vector stored in the word vector DB 12, for example, by Formula (2). The generation unit 31 determines whether or not each sentence is a negative sentence, rotates a sentence vector of the sentence determined to be a negative sentence by a specific angle, and amplifies the sentence vector by a predetermined factor. The generation unit 31 combines the sentence vector of the affirmative sentence and the sentence vector of the negative sentence that is rotated by a specific angle and amplified, for example, by Formula (3), and generates a search vector representing the search text.

By using the search vector representing the search text generated by the generation unit 31 and each of the document vectors representing each of the plurality of search target documents stored in the document vector DB 13, the search unit 32 calculates the degree of similarity between the search text and each of the search target documents. For example, the degree of similarity may be a cosine similarity between the search vector and the document vector. Based on the calculated similarity, the search unit 32 creates a search result of the search target document and transmits the search result to the user terminal 40. For example, the search result may be a list of a predetermined number of search target documents in descending order of similarity to the search text or search target documents having similarity equal to or higher than a predetermined value.

A problem in a case where the sentence vector of the negative sentence is inverted when a document vector representing a search target document and a search vector representing a search text are generated will be described. A case where the sentence vector is inverted is, for example, a case where the sentence vector is rotated by 180 degrees or −180 degrees. In this case, the inverted sentence vector of the negative sentence and the sentence vector of the affirmative sentence cancel each other out, and when these are combined, an appropriate document vector is not generated. Accordingly, 180 degrees or −180 degrees are excluded from the specific angles at which the sentence vector of the negative sentence is rotated. The reason for this will be described in detail.

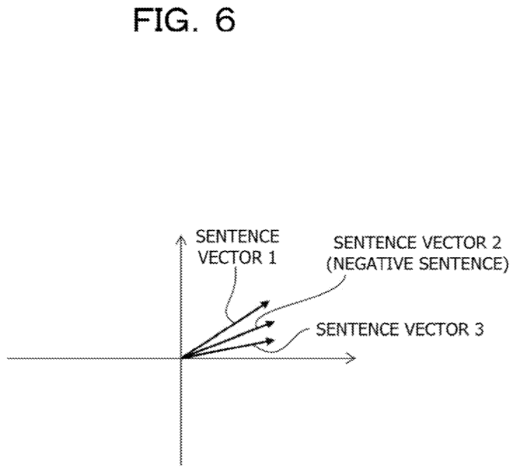

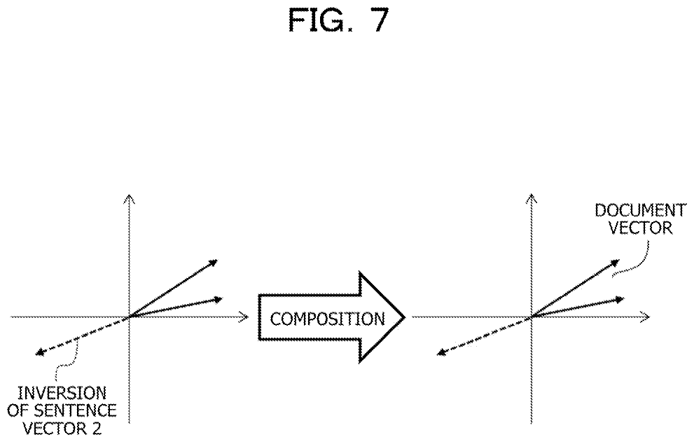

As an example, suppose that there is a search target document “I went to the office yesterday. I don't go to the office today. I will go to the office tomorrow”. This search target document is divided into sentences, for example, a sentence 1 “I went to the office yesterday”, a sentence 2 “I don't go to the office today”, and a sentence 3 “I will go to the office tomorrow”. For the sentences 1, 2, and 3, sentence vectors 1, 2, and 3 are generated, respectively. FIG. 6 illustrates an example of the sentence vectors 1, 2, and 3. Although the vector space is an N-dimensional space corresponding to the number of elements of the vector, a two-dimensional space is illustrated in FIG. 6 for simplification of description. The same applies to FIG. 7 to FIG. 10 described below. Although the sentence 2 is a negative sentence, since the word vectors of the base form of the words “office” and “go” are used when generating the sentence vectors, the sentence vectors 1, 2, and 3 are also approximate each other as illustrated in FIG. 6.

As illustrated in FIG. 7, suppose that the sentence vector 2 of the sentence 2 as the negative sentence is inverted and combined with the sentence vectors 1 and 3 to generate a document vector. In this case, the sentence vectors 1 and 3 of the sentences 1 and 3 as the affirmative sentence and the sentence vector 2 of the sentence 2 as the negative sentence cancel each other out. For this reason, the document vector to be generated is a vector extending in the same direction as the sentence vector of the affirmative sentence, and the components of the negative sentence are canceled out.

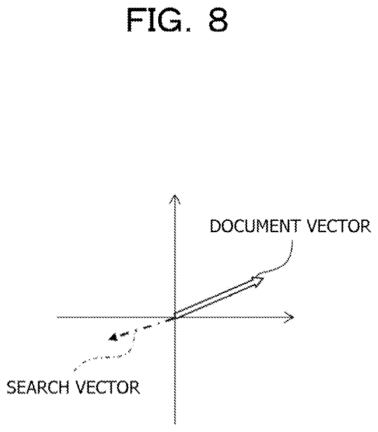

By contrast, a case of searching with search text “I don't go to the office” is considered. Also in the case of the search text, when the sentence vector of the negative sentence is inverted, as illustrated in FIG. 8, the search vector is a vector extending in substantially the same direction as the vector obtained by inverting the sentence vector 2 of the above search target document. In this case, the value of the cosine similarity between the search vector and the document vector of the search target document decreases.

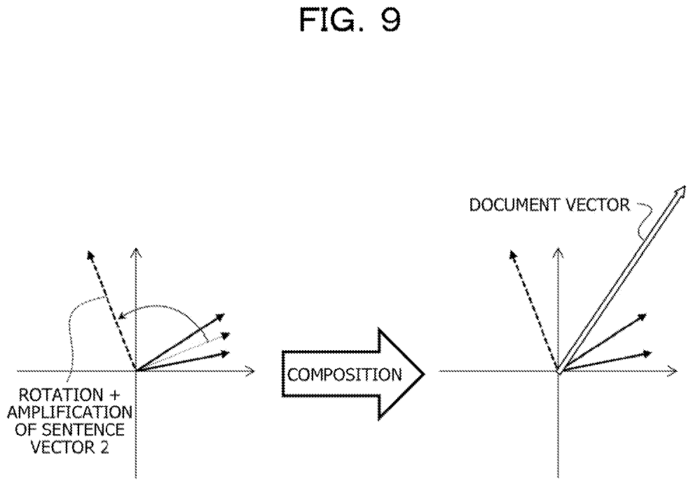

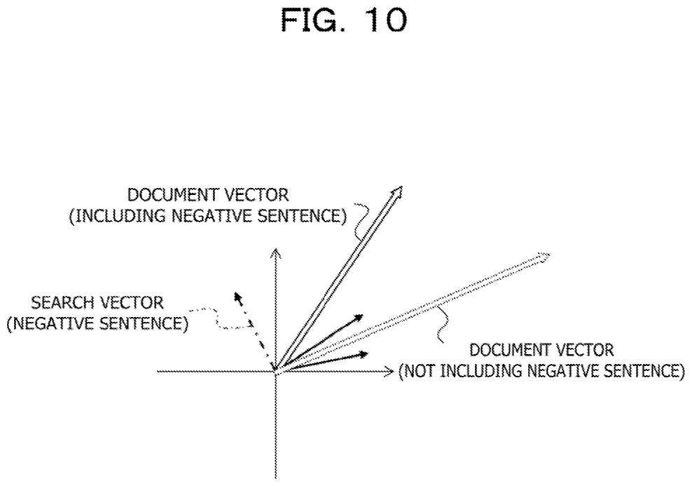

According to the present embodiment, as illustrated in FIG. 9, by rotating the sentence vector of the negative sentence by an angle in a range excluding 180 degrees or −180 degrees (for example, 90 degrees or −90 degrees), it is possible to generate the document vector while suppressing cancellation of the components of the negative sentence as described above. FIG. 9 illustrates an example in which amplification is performed together with rotation of the sentence vector of the negative sentence. By generating a search vector for the search text “I don't go to the office” described above in the same manner, as illustrated in FIG. 10, the cosine similarity with the document vector increases as compared with the case where the sentence vector of the negative sentence is inverted. A case will be described where the sentence 2 is “I go to the office today” and is compared with a search target document not including the negative sentence. For a search vector representing search text including a negative sentence, a cosine similarity with a document vector of a search target document including a negative sentence is larger than a cosine similarity with a document vector of a search target document not including a negative sentence. For example, in the present embodiment, in a case where a search is performed using search text including a negative sentence, it is possible to search a search target document including the negative sentence as being semantically closer than a search target document not including a negative sentence.

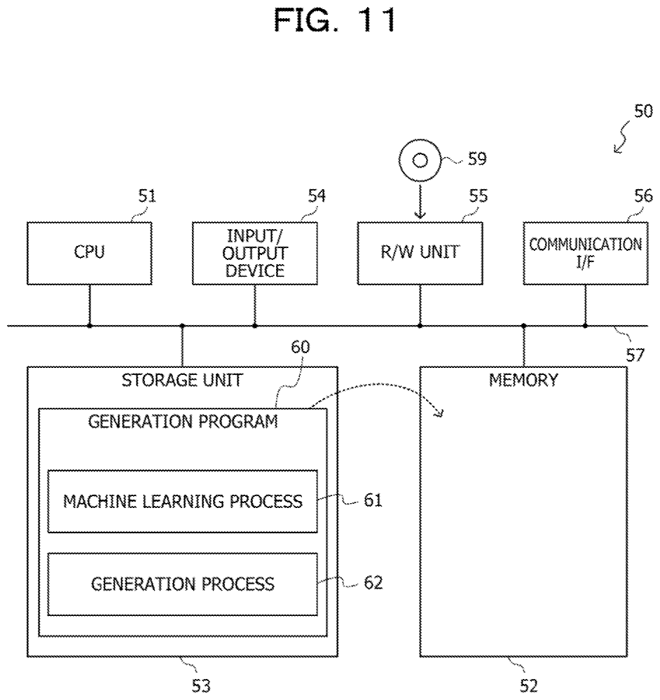

For example, the generation device 20 may be achieved by a computer 50 illustrated in FIG. 11. The computer 50 includes a central processing unit (CPU) 51, a memory 52 serving as a temporary storage area, and a storage unit 53 that is nonvolatile. The computer 50 also includes an input/output device 54 such as an input unit, a display unit, and the like and a read/write (R/W) unit 55 that controls reading and writing of data from and to a storage medium 59. The computer 50 also includes a communication interface (I/F) 56 that is coupled to a network such as the Internet. The CPU 51, the memory 52, the storage unit 53, the input/output device 54, the R/W unit 55, and the communication I/F 56 are coupled to each other via a bus 57.

The storage unit 53 may be achieved by using a hard disk drive (HDD), a solid-state drive (SSD), a flash memory, or the like. A generation program 60 for causing the computer 50 to function as the generation device 20 is stored in the storage unit 53 serving as a storage medium. The generation program 60 includes a machine learning process 61 and a generation process 62.

The CPU 51 reads the generation program 60 from the storage unit 53, loads the generation program 60 in the memory 52, and sequentially executes the processes included in the generation program 60. By executing the machine learning process 61, the CPU 51 operates as the machine learning unit 21 illustrated in FIG. 2. By executing the generation process 62, the CPU 51 operates as the generation unit 22 illustrated in FIG. 2. In this way, the computer 50 that executes the generation program 60 functions as the generation device 20. The CPU 51 that executes the program is hardware.

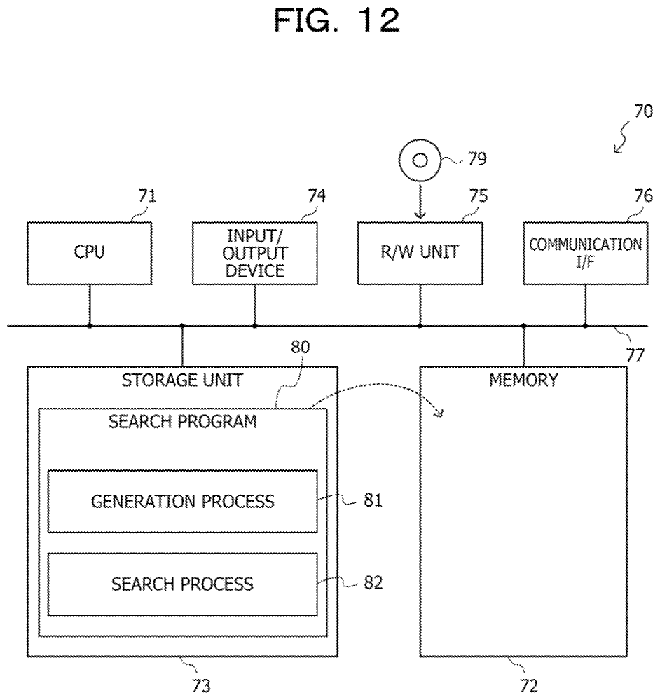

The search device 30 may be achieved by, for example, a computer 70 illustrated in FIG. 12. The computer 70 includes a CPU 71, a memory 72 serving as a temporary storage area, and a storage unit 73 that is nonvolatile. The computer 70 also includes an input/output device 74, an R/W unit 75 that controls reading and writing of data from and to a storage medium 79, and a communication I/F 76. The CPU 71, the memory 72, the storage unit 73, the input/output device 74, the R/W unit 75, and the communication I/F 76 are coupled to each other via a bus 77.

The storage unit 73 may be achieved by an HDD, an SSD, a flash memory, or the like. The storage unit 73 serving as a storage medium stores a search program 80 for causing the computer 70 to function as the search device 30. The search program 80 includes a generation process 81 and a search process 82.

The CPU 71 reads the search program 80 from the storage unit 73, loads the search program 80 in the memory 72, and sequentially executes the processes included in the search program 80. By executing the generation process 81, the CPU 71 operates as the generation unit 31 illustrated in FIG. 2. By executing the search process 82, the CPU 71 operates as the search unit 32 illustrated in FIG. 2. In this way, the computer 70 that executes the search program 80 functions as the search device 30. The CPU 71 that executes the program is hardware.

The functions realized by each of the generation program 60 and the search program 80 may also be realized by using, for example, a semiconductor integrated circuit, and more specifically, an application-specific integrated circuit (ASIC) or the like.

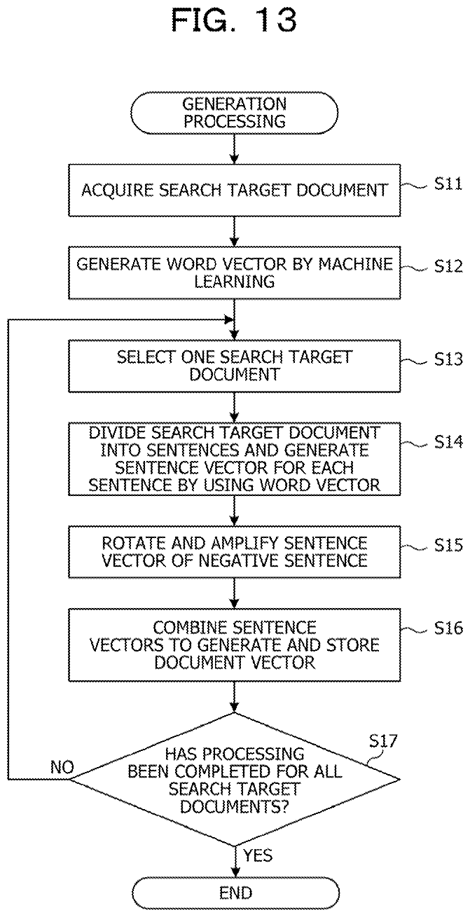

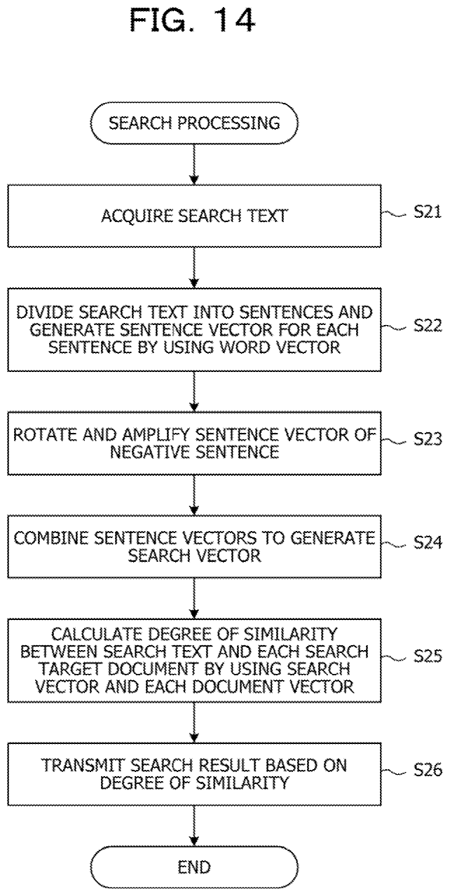

An operation of the search system 100 according to the present embodiment will now be described. When the generation device 20 is instructed to generate a word vector and a document vector in a state where a plurality of search target documents is stored in the document DB 11, the generation device 20 executes generation processing illustrated in FIG. 13. The word vector and the document vector generated by the generation device 20 are stored in the word vector DB 12 and the document vector DB 13, respectively. In this state, when the search device 30 receives the search text transmitted from the user terminal 40, the search device 30 executes search processing illustrated in FIG. 14. Each of the generation processing and the search processing will be described in detail below. The search processing is an example of a search method of the disclosed technique.

First, the generation processing illustrated in FIG. 13 is described.

In step S11, the machine learning unit 21 acquires each of the plurality of search target documents stored in the document DB 11. Next, in step S12, the machine learning unit 21 performs morphological analysis on each of the acquired search target documents, and extracts a base form of a word having a meaning, a part of speech of the word being a noun, a verb, an adjective, or the like, from a morphological analysis result. From the extracted base form of the word, the machine learning unit 21 executes machine learning by using, for example, a neural network to thereby generate a word vector. The machine learning unit 21 stores the generated word vector in the word vector DB 12.

Next, in step S13, the generation unit 22 selects, from the plurality of acquired search target documents, one search target document on which the processing in steps S14 to S16 described below has not been performed. Next, in step S14, the generation unit 22 divides the selected search target document into sentences, and generates a sentence vector for each sentence by using the word vectors stored in the word vector DB 12.

Next, in step S15, the generation unit 22 determines whether or not each sentence is a negative sentence, rotates a sentence vector of the sentence determined to be a negative sentence by a specific angle in a specific biaxial plane, and amplifies the sentence vector by a predetermined factor. Next, in step S16, the generation unit 22 combines the sentence vector of the affirmative sentence generated in step S14 above and the sentence vector of the negative sentence that is rotated by a specific angle and amplified in step S15 above, and generates a document vector representing the selected search target document. The generation unit 22 stores the generated document vector in the document vector DB 13.

Next, in step S17, the generation unit 22 determines whether or not the processing of generating document vectors has been completed for all the acquired search target documents. When there is an unprocessed search target document, the process returns to step S13, and when the processing is completed for all the search target documents, the generation processing ends.

Next, the search processing illustrated in FIG. 14 will be described.

In step S21, the generation unit 31 acquires the search text transmitted from the user terminal 40. Next, in step S22, the generation unit 31 generates a sentence vector for each sentence of the search text in the same processing as in step S14 of the above generation processing (FIG. 13). Next, in step S23, the generation unit 31 determines whether or not each sentence is a negative sentence, rotates the sentence vector of the sentence determined to be a negative sentence by a specific angle, and amplifies the sentence vector by a predetermined factor. Next, in step S24, the generation unit 31 combines the sentence vector of the affirmative sentence and the sentence vector of the negative sentence that is rotated by a specific angle and amplified, and generates a search vector representing the search text.

Next, in step S25, the search unit 32 calculates the degree of similarity between the search text and each of the search target documents by using the search vector generated in step S24 above and each of the plurality of document vectors stored in the document vector DB 13. Next, in step S26, the search unit 32 creates a search result of the search target document based on the calculated similarity and transmits the search result to the user terminal 40, and then the search processing ends.

As described above, in the search system according to the present embodiment, when search text is received, the search device generates a sentence vector for each sentence included in the search text based on a vector indicating each word and one or a plurality of words included in the search text. When a sentence indicating negation is included in the search text, the search device generates a search vector by rotating a sentence vector of the sentence by a specific angle to be combined with a sentence vector of the affirmative sentence, and executes text search processing by using the search vector. By contrast, when a sentence indicating negation is not included in the search text, the search device executes the text search processing by using a search vector obtained by combining the sentence vectors as they are. A document to be subjected to the search processing is also vectorized by the same method. Accordingly, it is possible to search a document while distinguishing between the affirmative and negative sentences.

Although the case where the generation device and the search device are achieved by separate computers has been described in the above embodiment, the generation device and the search device may be achieved by a single computer. Although the case where the document DB, the word vector DB, and the document vector DB are stored in the data storage device has been described in the above embodiment, these DBs may be stored in, for example, a predetermined storage area of the search device.

Although an aspect in which the generation program and the search program are stored (installed) in the storage unit in advance has been described in the above embodiment, the present disclosure is not limited thereto. The program according to the disclosed technique may also be provided in a form in which the program is stored in a storage medium such as a compact disc read-only memory (CD-ROM), a Digital Versatile Disc (DVD)-ROM, or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a search program that causes at least one computer to execute a process, the process comprising:
generating, when search text is received, a first vector that indicates the search text based on a vector that indicates a word included in the search text;
generating, when a word that indicates negation is included in the search text, a second vector obtained by rotating the first vector by a certain angle;
executing text search processing by using the second vector when the second vector is generated; and
executing the text search processing by using the first vector when the second vector is not generated.

2. The non-transitory computer-readable recording medium according to claim 1, wherein a vector that indicates the word is a distributed representation of a base form of a word that has a meaning.

3. The non-transitory computer-readable recording medium according to claim 1, wherein the process further comprising:
when the search text includes a plurality of sentences, generating a plurality of third vectors each of that indicates each of the plurality of sentences based on a vector that indicates a word included in the plurality of sentences;
when there is no sentence in which a word that indicates the negation is included in the search text, generating the first vector by combining the plurality of third vectors; and
when there is a sentence in which a word that indicates the negation is included in the search text, generating a plurality of fourth vectors obtained by rotating the plurality of third vectors by the certain angle for a sentence in which a word that indicates the negation is included, and generating the second vector by combining the plurality of third vectors for a sentence in which a word that indicates the negation is not included and by combining the plurality of fourth vectors for a sentence in which a word that indicates the negation is included.

4. The non-transitory computer-readable recording medium according to claim 3, wherein the generating the second vector includes combining the fourth vector by being amplified by a certain factor.

5. The non-transitory computer-readable recording medium according to claim 1, wherein the certain angle is 90 degrees or minus 90 degrees.

6. The non-transitory computer-readable recording medium according to claim 1, wherein the process further comprising:
generating the first vector for a search target document in which a word that indicates the negation is not included;
generating the second vector for a search target document in which a word that indicates the negation is included,
wherein the text search processing includes searching the search target document similar to the search text based on a degree of similarity between a vector indicating the search text and a vector indicating the search target document, the vector indicating the search text being selected from the first vector and the second vector, the vector indicating the search target document being selected from the first vector and the second vector.

7. A search device comprising:
one or more memories; and
one or more processors coupled to the one or more memories and the one or more processors configured to:
generate, when search text is received, a first vector that indicates the search text based on a vector that indicates a word included in the search text,
generate, when a word that indicates negation is included in the search text, a second vector obtained by rotating the first vector by a certain angle,
execute text search processing by using the second vector when the second vector is generated, and
execute the text search processing by using the first vector when the second vector is not generated.

8. The search device according to claim 7, wherein a vector that indicates the word is a distributed representation of a base form of a word that has a meaning.

9. The search device according to claim 7, wherein the one or more processors are further configured to:
when the search text includes a plurality of sentences, generate a plurality of third vectors each of that indicates each of the plurality of sentences based on a vector that indicates a word included in the plurality of sentences,
when there is no sentence in which a word that indicates the negation is included in the search text, generate the first vector by combining the plurality of third vectors, and
when there is a sentence in which a word that indicates the negation is included in the search text, generate a plurality of fourth vectors obtained by rotating the plurality of third vectors by the certain angle for a sentence in which a word that indicates the negation is included, and generate the second vector by combining the plurality of third vectors for a sentence in which a word that indicates the negation is not included and by combining the plurality of fourth vectors for a sentence in which a word that indicates the negation is included.

10. The search device according to claim 9, wherein the one or more processors are further configured to
combine the fourth vector by being amplified by a certain factor.

11. The search device according to claim 7, wherein the certain angle is 90 degrees or minus 90 degrees.

12. The search device according to claim 7, wherein the one or more processors are further configured to:
generate the first vector for a search target document in which a word that indicates the negation is not included,
generate the second vector for a search target document in which a word that indicates the negation is included,
wherein the text search processing includes searching the search target document similar to the search text based on a degree of similarity between a vector indicating the search text and a vector indicating the search target document, the vector indicating the search text being selected from the first vector and the second vector, the vector indicating the search target document being selected from the first vector and the second vector.

13. A search method for a computer to execute a process comprising:
generating, when search text is received, a first vector that indicates the search text based on a vector that indicates a word included in the search text;
generating, when a word that indicates negation is included in the search text, a second vector obtained by rotating the first vector by a certain angle;
executing text search processing by using the second vector when the second vector is generated; and
executing the text search processing by using the first vector when the second vector is not generated.

14. The search method according to claim 13, wherein a vector that indicates the word is a distributed representation of a base form of a word that has a meaning.

15. The search method according to claim 13, wherein the process further comprising:
when the search text includes a plurality of sentences, generating a plurality of third vectors each of that indicates each of the plurality of sentences based on a vector that indicates a word included in the plurality of sentences;
when there is no sentence in which a word that indicates the negation is included in the search text, generating the first vector by combining the plurality of third vectors; and
when there is a sentence in which a word that indicates the negation is included in the search text, generating a plurality of fourth vectors obtained by rotating the plurality of third vectors by the certain angle for a sentence in which a word that indicates the negation is included, and generating the second vector by combining the plurality of third vectors for a sentence in which a word that indicates the negation is not included and by combining the plurality of fourth vectors for a sentence in which a word that indicates the negation is included.

16. The search method according to claim 15, wherein the generating the second vector includes combining the fourth vector by being amplified by a certain factor.

17. The search method according to claim 13, wherein the certain angle is 90 degrees or minus 90 degrees.

18. The search method according to claim 13, wherein the process further comprising:
generating the first vector for a search target document in which a word that indicates the negation is not included;
generating the second vector for a search target document in which a word that indicates the negation is included,
wherein the text search processing includes searching the search target document similar to the search text based on a degree of similarity between a vector indicating the search text and a vector indicating the search target document, the vector indicating the search text being selected from the first vector and the second vector, the vector indicating the search target document being selected from the first vector and the second vector.
